(19) United States
(12) Patent Application Publication
(10) Pub. No.: US 2005/0072069 A1
(43) Pub. Date: Apr. 7, 2005

(54) Fluid induced acoustic generator

(76) Inventor: Paul J. Kovach, Sandy, UT (US)

Correspondence Address: GRANT R CLAYTON;CLAYTON HOWARTH & CANNON, PC, P O BOX 1909, SANDY, UT, 84091-1909, US

(21) Appl. No.: 10/841,210

(22) Filed: May 7, 2004

Related U.S. Application Data
(60) Provisional application No. 60/469,340, filed on May 9, 2003.

(51) Int. Cl. E06B 1/38

(52) U.S. Cl. 52/167.1

(57) ABSTRACT

A fluid induced acoustic generator comprising a horizontal like surface and structure to avoid the puddling of falling water on its surface. The generator is rigid to avoid undesirable movement in the wind and to increase the effectiveness of sound generation.

### CROSS-REFERENCE TO RELATED APPLICATIONS

This application claims the benefit of U.S. Provisional Application No. 60/469,340, filed May 9, 2003, which is hereby incorporated by reference herein in its entirety, including but not limited to those portions that specifically appear hereinafter.

### STATEMENT REGARDING FEDERALLY SPONSORED RESEARCH OR DEVELOPMENT

Not Applicable.

### BACKGROUND OF THE INVENTION

1. The Field of the Invention

This invention relates to musical outdoor decorative products.

2. Description of Related Art

As a kid, I remember sitting under the metal roof and listing to the rain fall upon it. It was always nice to hear the gentle thumping of rain as it fell upon the roof. Many people enjoy hearing the thumping or drumming noise created when rain hits a metal roof, but in today's homes with wooden roofs and insulation it has almost become a thing of the past. Until this invention, the only way to hear the rain fall was to move near a metal shed, carport, or other metal out door structure. This invention allows the user to create the same effect as a metal roof in a convenient location, so that when it rains the sound of rain falling can be heard. The illustrative embodiment of the present invention will provide the owner with countless hours of enjoyment.

### SUMMARY OF THE ILLUSTRATIVE EMBODIMENTS OF THE INVENTION

The present invention is easily installed and movable, it allows the user to place it in a beneficial location. In the years to come it will provide countless hours of enjoyment with little or no maintenance.

The illustrative embodiments of the present invention may be made from several different types of metal, which when struck by falling water will produce different drumming sounds. Several illustrative embodiment of the present inventions may be placed together so that the different tones may be appreciated, much like wind chimes. The illustrative embodiment of the present invention may also be placed at different heights, and so that the edge of one overlaps another. This would create a unique sound as water from one drum trickles down onto another. Another property of the illustrative embodiment of the present invention is its appearance. It can be available in different metals, for example: copper, brass, and stainless steel. Illustrative embodiments of the present inventions may also come in a variety of shapes (see drawings). When placed in a garden or another decorative environment, they also act as lawn decorations. A wide variety of decorative options may be available. An individual could utilize different metals or designs as decorations. For example: copper will turn green with time, brass and stainless will retain their color. This provides the owner three different color options to decorate with, green, silver, and gold. A person could choose a shape that enhances their yards natural beauty or decor. For instance; a round illustrative embodiment of the present invention could be used as a simple addition to a flower bed, while a square illustrative embodiment of the present invention would be a unique addition to a garden that already has an existing theme, for example a zen garden. Rain thumpers may be made from many colors, metals, and methods the previous are just few of the many examples. Therefore the illustrative embodiment of the present invention cannot only act as a device for making a drumming noise in the rain but would also act as a decorative lawn ornament. Thus not only enhancing the owner's lawn, garden or other, but providing countless hours of drumming pleasure during the rain.

Accordingly, advantages of my invention are: The invention allows the user to position the illustrative embodiment of the present invention anywhere for convenience; it provides a calming, soothing, sound as the rain falls, it provides insight into the current weather situation, it creates the sound of “rain on the roof” without the hassle or expense of building a metal roof.

While cymbals may resemble the illustrative embodiment of the present invention they are different in many ways, for instance; cymbals are commonly made from three main alloys: Bell bronze, Malleable Bronze, and Brass nickle. The first of the two are made from a tin copper mixture with no more than 20% tin. The latter is a mixture of copper and nickle. The purpose of these mixtures was to provide a metal that would give a “crashing” sound when struck (as referred to by musicians). Because illustrative embodiment of the present inventions are not intended to produce a “crashing” sound when struck, they can be produced from softer and likewise various metal. Metals that would normally be unfeasible for cymbals can be used for illustrative embodiment of the present inventions such as stainless steel, copper, brass, and galvanized metal. Furthermore the material can be thinner, of or about 18 ga, because it is not intended to be struck by drumsticks or other hard mediums. Both of these elements allow for a cheaper disk to be produced, comparatively a illustrative embodiment of the present invention of the same diameter can be purchased for about 1/50 the cost of a quality cymbal. While the purpose of the cymbal is to provide a “crashing” sound when struck. The illustrative embodiment of the present invention is designed to produce a “thumping” or “drumming” noise similar to rain on the roof. An expert in the field of music would find the illustrative embodiment of the present invention to be an unacceptable substitute for a cymbal. Since illustrative embodiment of the present inventions are constructed of a thinner metal, they will have a curvature along an edge or rigidness integrated into the design so that they do not “flop” in the wind. Cymbals are constructed of a thicker metal, and therefore this is not necessary. By design illustrative embodiment of the present inventions are made to transfer the kinetic energy from falling rain into sound. Illustrative embodiments of the present invention are made from a thin, light material that produces a thumping sound when struck. If the material is too thick, a suitable sound will not be produced. Illustrative embodiments of the present inventions have a curved surface area that allows for water to drain, and a point of attachment that permits the illustrative embodiment of the present invention to vibrate when impelled upon by falling water. Another important aspect of the illustrative embodiments of the present invention is the size. If the surface area is too small it will not provide sufficient area for the rain to fall upon, thus the illustrative embodiments of the present inventions should have a surface area greater than about 0.25 square foot, or grater than about 0.5 square foot, or greater than about 1.0 square foot.

Like well-known wind chimes, the illustrative embodiments of the present inventions provide a melodious experience in cooperation with ever-changing weather conditions. Further advantages of my invention will become apparent from a consideration of the drawings and ensuring description.

In summary, illustrative embodiments of the present inventions provide a calming, soothing sound by providing an adequate surface area that rain can fall upon and be heard for enjoyment or evaluation purposes. The material and structure of the embodiments provide an efficient system for changing kinetic energy of falling water into sound, producing a “thumping” or “drumming sound.” Desirably, the embodiments of the present invention can be fabricated so they will also provide a visually pleasing experience.

### DRAWINGS—FIGURES

FIG. 1 shows the illustrative embodiment of the present invention from an upper view.

FIG. 2 shows the illustrative embodiment of the present invention from a side view.

FIG. 3 shows the illustrative embodiment of the present invention fully mounted upon the support.

FIG. 4 shows an oval shaped illustrative embodiment.

FIG. 5 shows a raised square or pyramid shaped illustrative embodiment.

FIG. 6 shows a raised circle illustrative embodiment of the present invention.

FIG. 7 shows the raised circle illustrative embodiment of the present invention from a side view.

FIG. 8 shows a circular illustrative embodiment of the present invention with four attachment points.

FIG. 9 shows a doughnut shaped illustrative embodiment of the present invention.

FIG. 10 shows a circular shaped illustrative embodiment of the present invention fully mounted on a post like device.

### DRAWINGS—REFERENCE NUMBERS

2 Body of the illustrative embodiments of the present invention

4 Spacer

6 Nut

8 Washer

10 Support

### DETAILED DESCRIPTION

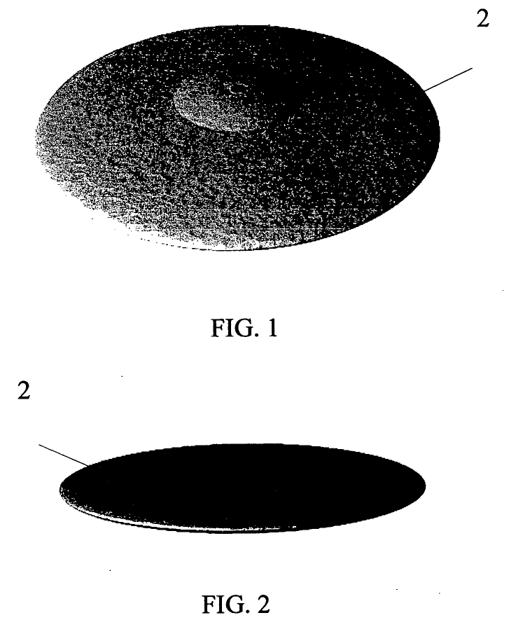

FIG. 1 shows the illustrative embodiment of the present invention from an upper view, and shows it is made a thin sheet of metal or other material that will produce a drumming sound when rain, hail, or any other type of falling liquid, the liquid being fluid or congealed, strikes it. Most illustratively, it will be round although it can take any shape. It has a curvature or slope so that water does not accumulate upon it. They may also be curved to produce a rigidness so that it will not “flop” in the wind. Illustrative embodiments of the present invention can be produced from many different materials including but not limited to brass, copper, stainless steel, and galvanized metal. The shape can also be various, for instance: they could be round (as shown in FIG. 1) oval, square, rectangular, triangular, etc.

FIG. 2 shows the illustrative embodiment of the present invention from a side perspective so that the curvature is more apparent. In this Fig. the shape of the illustrative embodiment of the present invention is shown round and bent so that water drains to the outside of the illustrative embodiment of the present invention.

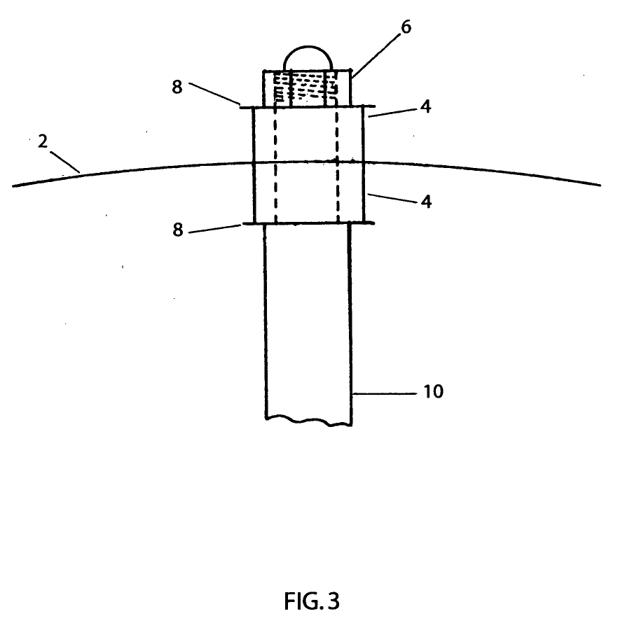

FIG. 3 shows the illustrative embodiment of the present invention installed on one of the various methods of support. Working up from the support there is a washer (8) placed on an area where the support becomes narrower. On top of the washer is a spacer (4) whereas the washer acts as a support for the spacer. On top of the spacer the illustrative embodiment of the present invention (2) is placed and then another spacer (4) is placed. So that the illustrative embodiment of the present invention is located between two spacers. The reason the illustrative embodiment of the present invention is placed between two spacers is that they are both made of soft material so that the illustrative embodiment of the present invention may be held in place but be free to vibrate when impelled upon by falling liquid, such as water. Upon the top spacer a second washer (8) is then placed and a nut (6) is then threaded down over the main support shaft so that the whole assembly is held together.

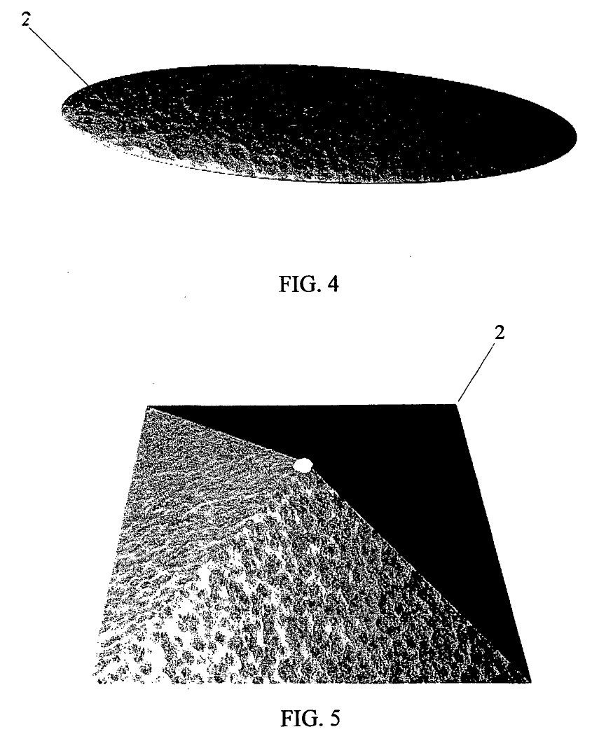

FIG. 4 shows an upper view of an oval shaped embodiment of the present invention. As indicated earlier, the illustrative embodiments of the present inventions can be of any size or shape. FIG. 4 shows just one of the many variations that can be used. FIG. 4 represents a single point attachment embodiment of the present invention.

FIG. 5 shows an upper view of an illustrative embodiment of the present invention having a pyramid design. Water rolls off to the outside of the illustrative embodiment of the present invention shown in FIG. 5 so that it does not accumulate on the surface causing a dampening effect. The rigidness in the illustrated embodiment comes from the pyramidal shape, rather than a curvature shape.

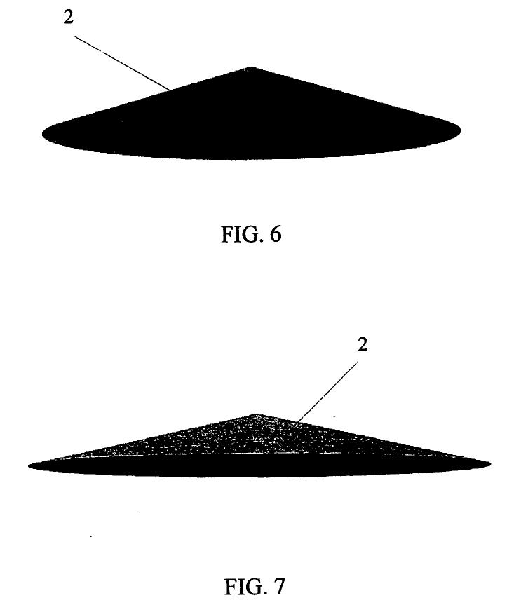

FIG. 6 shows another embodiment of the present invention. FIG. 6 is an upper view showing the single point attachment and is made so water rolls of to the side.

FIG. 7 shows the same illustrative embodiment of the present invention as represented in FIG. 6. This is from the side view so the conical shape can be better seen.

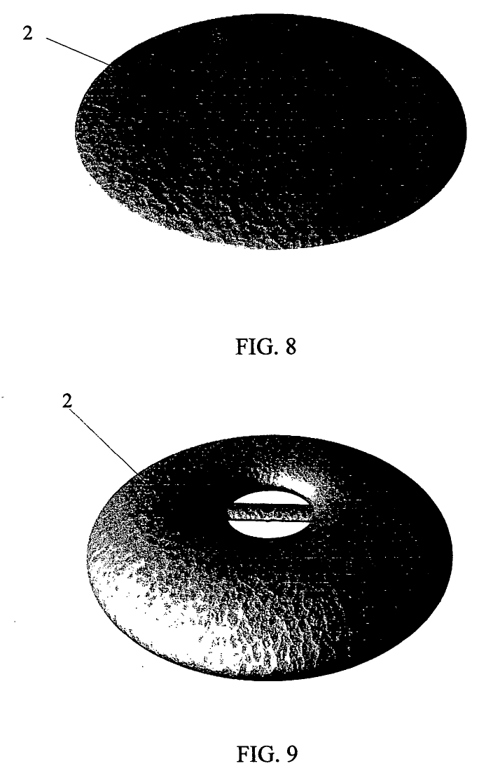

FIG. 8 shows a illustrative embodiment of the present invention with multiple points for attachment. This particular illustrative embodiment of the present invention drains to the exterior and has a bell shape for rigidness. The multiple points may be used to hang the illustrative embodiment of the present invention from a support, possibly a support beam.

FIG. 9 shows an upper view of a doughnut shaped embodiment of the present invention. In this design the shape provides rigidness, and water can drain from the center as well as the exterior edges. The support point is provided in the center region and features an alternative method of attachment. In this example the center is equipped with a center bracket that allows for mounting.

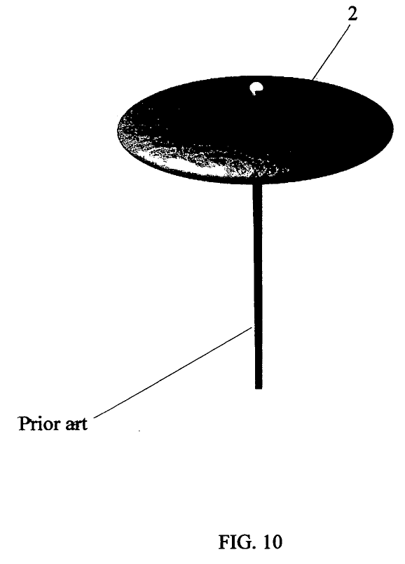

FIG. 10 shows an upper view of the illustrative embodiment of the present invention fully mounted on a post like device (which is know in the industry in connection with other devices). This is an example of a round, center mounted embodiment of the present invention fabricated so that water will drain from the exterior edge.

### OPERATION OF THE ILLUSTRATIVE EMBODIMENTS OF INVENTION

The illustrative embodiments of the present invention are illustratively placed in an area in which rain will fall and where the sound of the illustrative embodiments of the present invention can be enjoyed. Rain, hail, or water from another source strikes the illustrative embodiment of the present invention causing it to “drum” recreating the sound of rain hitting a roof. Several illustrative embodiment of the present inventions may be placed together, with some under others to create a more dramatic effect, or the may be used singularly. Once installed the illustrative embodiment of the present invention requires very little maintenance.

### CONCLUSION, RAMIFICATIONS AND SCOPE OF INVENTION

As will now be appreciated, illustrative embodiments of the present inventions can be an enjoyable, almost maintenance free garden fixture that will provide countless hours of enjoyment. While the above-provided description contains many specificities, these should not be construed as limitations on the scope of the invention, but rather as an exemplification of the preferred embodiments thereof. Many other variations are possible. For example, the illustrative embodiments of the present invention may be square, oval or of another shape. The material could be various types including, but not limited to metal, plastic, fiberglass, or glass. The point of attachment can very greatly not only in position but in type. It may consist of a bracket, a system incorporating bushings, or another means. The point of attachment may be in the center, side, or edge. Accordingly, the scope of the invention should be determined not by the illustrated embodiments but by the appended claims and their equivalents.

1. An instrument comprising:
a horizontal like surface;
a design to avoid the puddling of water on the surface;
that is rigid to avoid flopping in the wind;
that is rigid to increase the effectiveness of the sound making ability.

2. An instrument as in claim 1 wherein the instrument is at least partially fabricated from a metal.

3. A musical like instrument adapted to produce a thumping sound when struck by a falling liquid.

4. The instrument of claim 3 adapted to be placed outside for reference of natural phenomena.

5. The instrument of claim 3 which has a surface area larger than 1 square foot.

6. The instrument of claim 3 comprising a material that is efficient at changing the kinetic energy of falling water into sound.
